(19) United States
(12) Patent Application Publication
(10) Pub. No.: US 2007/0055000 A1
(43) Pub. Date: Mar. 8, 2007

(54) Polymeric compositions

(75) Inventor: George Barry Park, Oxford (GB)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Oxonica Limited, Kidlington, Oxfordshire (GB)

(21) Appl. No.: 10/555,570

(22) PCT Filed: May 5, 2004
(86) PCT No.: PCT/GB04/01909

§ 371 Date: Aug. 31, 2006

(30) Foreign Application Priority Data
May 6, 2003 (GB) 0310365.2

(51) Int. Cl. C08K 5/13

(52) U.S. Cl. 524/342

(57) ABSTRACT

A polymeric composition is described which comprises an amount of one or more organic or inorganic components which are photosensitive and/or which are degraded by another ingredient of the composition and an amount of Ti0₂ and/or ZnO which has been doped with a second element or the reduced ZnO, this composition having a rate of deterioration of UV light-sensitive physical factor at least 5% less than that of a composition having the same formulation except that it does not contain the said Ti0₂ and/or ZnO which has been doped with a second element or the said ZnO.

The present invention relates to polymeric compositions for a variety of uses.

It is well known that many polymeric compositions are adversely affected by light, in particular UV light This can result in a variety of physical properties of the composition being affected. Typically, solid plastics compositions have their strength adversely affected so that, over time, they become more brittle. Similar comments apply to coating compositions. Other properties which can be adversely affected include colour. It is well known, for example, that coating compositions such as paints are adversely affected by light so that fading or, in the case of white formulations, yellowing occurs.

Various attempts have been made to counteract these adverse effects. This has included incorporating light stabilisers into the composition, typically hindered amines. However, incorporation of such light stabilisers is relatively expensive and not always particularly effective.

The present invention resides in the discovery that the incorporation of particular types of titanium dioxide and zinc oxide can effectively counteract the adverse effect of exposure to light, typically sun light.

It has now surprisingly been found, according to the present invention, that the degradation of polymeric compositions can be retarded if the compositions also have present either zinc oxide or titanium dioxide which has been doped with a second element or reduced zinc oxide. In other words by using these doped materials or reduced zinc oxide rather than ordinary titanium dioxide or zinc oxide it is, for example, possible either to provide a polymeric composition which gives better protection against UV light or a composition having the same resistance to degradation but containing a smaller quantity of light stabiliser.

Accordingly the present invention provides a polymeric composition which comprises an amount of one or more organic or inorganic components which are photosensitive and/or which are degraded by another ingredient of the composition, and an amount of either TiO₂ and/or ZnO which has been doped with a second element and/or reduced ZnO, the composition having a rate of deterioration of a UV light-sensitive physical factor at least 5% less than that of a composition having the same formulation except that it does not contain the TiO₂ and/or ZnO which has been doped with a second element or reduced ZnO.

By a “physical factor” is meant a measurable value of a physical property of the composition which is adversely affected by UV light. Examples of such physical factors include degradation and, in consequence, strength, colour change e.g. for paints and textiles and photographic stability e.g. for photographic films.

Thus if the rate of deterioration of a physical factor is X then the amount of the component(s) which are photosensitive and/or which are degraded by another ingredient of the composition, possesses a said rate of deterioration of Y where Y is greater than X by at least 5%, and the amount of doped TiO₂ and/or ZnO and/or reduced ZnO reduces the said rate of loss from Y to X. The present invention also provides the use of a doped TiO₂/ZnO and/or reduced ZnO to reduce the concentration of one or more light stabilisers in a polymeric composition as well as to reduce the rate of deterioration of a physical factor of a polymeric composition The present invention further provides a method of improving the stability of a physical factor of a composition which comprises one or more components which are photosensitive and/or which are degraded by another ingredient of the composition which comprises incorporating into the composition a doped TiO₂/ZnO and/or reduced ZnO.

By “a polymeric composition” as used herein is meant a composition which comprises one or more polymeric materials. The composition can be solid or liquid.

In some instances, the composition of the present invention will contain TiO₂ and/or ZnO which has not been doped or, in the case of ZnO, reduced. Typically such undoped TiO₂/ZnO will be present as pigment, generally having a particle size of at least 100 nm.

Typical solid materials include polymeric solids including three dimensional objects, films and fibres as well as textiles and fabrics e.g. clothing and netting made from woven and non-woven fibres as well as foamed articles. Three-dimensional objects include those made by melt-forming processes including extruded and moulded articles. Typical articles to which the present invention may be applied include generally external household and building materials including blinds and plastics curtains, trellis, pipes and guttering, cladding and facings such as soffit board and plastics roofing material which can be profiled as with corrugated sheeting, doors and windows frames. Other articles include advertising hoardings and the like e.g. advertising boards on vehicle sides as well as vehicle bodies and body parts including bumpers for cars, buses and-trucks as well as roofs which can be used also for boats, as well as superstructures and hulls for boats and also bodies for lawnmowers and tractors and yachts, along with containers such as bottles, cans, drums, buckets and oil and water storage containers. Other objects include garden furniture.

Films to which the present invention can be applied include self supporting as well as non-self supporting films such as coatings. Self-supporting films to which the present invention applies include photographic films, packaging film and plastic film bearing indicia, typically as advertising film, which can also be applied over advertising hoardings. Such films can contain one or more customary ingredients for such products. Thus photographic film will contain one or more dyes or dye couplers and, optionally, a silver halide.

In some instances the polymeric composition itself is not liable to degradation but the composition is intended to protect a substrate or, in the case of a container, something placed in it Thus such compositions can contain the doped TiO₂/ZnO or reduced ZnO. Examples include pigmented and non-pigmented containers, typically bottles. Accordingly, the present invention also provides a self-supporting polymer composition, or a varnish composition, intended to protect a composition adjacent thereto from the adverse effects of light which comprises TiO₂ and/or ZnO which has been doped with a second element or reduced ZnO. In one embodiment the composition is 3-dimensional and comprises a surface layer with the TiO₂ and/or Zn while the non-surface part is generally not wood or a reconstituted wood such as chipboard, plywood or fibreboard and is preferably synthetic.

Coating compositions are typically paints and varnishes which contain a polymer either as the active ingredient as in some varnishes or as a support as in paints along with furniture polishes, waxes and creams; they can be aqueous or non aqueous i.e. contain an organic solvent. This coating composition can be in the form of a waterproofing agent. These coating compositions can contain one or more customary ingredients for such products. Some cosmetics compositions contain one or more polymers; such compositions are less preferred in the present invention.

The polymers which can be used in the compositions of the present invention include natural and synthetic polymers which may be thermoplastic or thermosetting.

The suitable polymers which may be homopolymers or copolymers which can be random, block or graft copolymers; the polymers can be crosslinked. Such polymers may be saturated or unsaturated. Typical polymers include alkylene polymers such as ethylene and propylene polymers, typically homopolymers, including polyethylene foams, including PTFE, siloxane and sulphide polymers, polyamides such as nylon, polyesters such as PET, acrylate and methacrylate polymers e.g. poly(methyl methacrylate), polyurethanes, including foams, vinyl polymers such as styrene polymers e.g. ABS, including polystyrene foam vinyl chloride polymers and polyvinyl alcohol. Fluorinated polymers such as PTFE and polyvinylidene fluoride can be used. The polymers can be thermosetting as with epoxy resins as well as phenolic, urea, melamine and polyester resins

Natural polymers which can be used include cellulosic polymers, as in paper including starch, polysaccharides, lignins, and polyisoprenes such as natural rubbers.

It will be appreciated that some polymers can be regarded as photostable in that there is no, or no significant, change in physical characteristics on exposure to UV light. These polymers are, therefore, not photosensitive and their use does not fall within the scope of the present invention.

Typical polymers for different applications include the following: (a) polyester, polyamide e.g. nylon, acrylics for fibres and fabrics; (b) polyester, polyvinyl chloride, polyethylene, polypropylene for bottles and the like; (c) polyethylene, polypropylene, polyvinyl chloride for film (non active such as packaging).

The compositions can contain the usual additional ingredients characteristic for the composition in question including inorganic and organic pigments, including “ordinary” TiO₂ and/or ZnO, fillers and extenders as well as light stabilisers, typically hindered amine stabilisers.

The rate of colour change can be determined by illuminating a sample of the composition with and without the doped TiO₂ or ZnO or reduced ZnO with sunlight or visible light and measuring the spectral response of the composition over a given period and determining the change in wavelength emitted. Accelerated ageing tests using, for example a Fadeometer, can be used for this purpose.

The rate of loss of strength of an article of the present invention can be determined in a similar manner by measuring tensile properties such as the elongation at break or Young's modulus using standard equipment such as an Instron tester; again an accelerated ageing procedure is beneficial.

While any reduction in the wavelength change or other physical factor is an advantage, it is generally desirable that the presence of the doped oxide should reduce the rate of change by an amount of at least 5%, preferably at least 10%, more preferably at least 15%, especially at least 20% and most preferably at least 40%.

The dopant for the oxide paiticles is preferably manganese, which is especially preferred, e.g. Mn²⁺ but especially Mn³⁺, vanadium, for example V³⁺ or V⁵⁺, chromium and iron but other metals which can be used include nickel, copper, tin, aluminium, lead, silver, zirconium, zinc, cobalt, gallium, niobium, for example Nb⁵⁺, antimony, for example Sb³⁺, tantalum, for example Ta⁵⁺; strontium, calcium, magnesium, barium, molybdenum, for example Mo³⁺, Mo⁵⁺ or Mo⁶⁺ as well as silicon. Manganese is preferably present as Mn³⁺, as well as Mn²⁺ cobalt as Co²⁺ and tin as Sn⁴⁺. These metals can be incorporated singly or in combination of 2 or 3 or more. Further details of these doped oxides can be found in WO99/60994 as well as WO11/40114.

The optimum amount of the dopant in the host lattice of the doped materials may be determined by routine experimentation but it is preferably low enough so-that the particles are not coloured. Amounts as low as 0.1 mole % or less, for example 0.05 mole %, or as high as 1 mole % or above, for example 5 mole % or 10 mole %, can generally be used. Typical concentrations are from 0.5 to 2 mole % by weight.

These particles can be obtained by any one of the standard processes for preparing doped oxides and salts. Thus they can be obtained by a baking technique by combining particles of a host lattice (TiO₂/ZnO) with a second component in the form of a salt such as a chloride or an oxygen-containing anion such as a perchlorate or a nitrate, in solution or suspension, typically in solution in water, and then baking it, typically at a temperature of at least 300° C. Other routes which may be used to prepare the doped materials include a precipitation process of the type described in J. Mat. Sci. (1997) 36, 6001-6008 where solutions of the dopant salt and of an alkoxide of the host metal (Ti/Zn) are mixed, and the mixed solution is then heated to convert the alkoxide to the oxide. Heating is continued until a precipitate of the doped material is obtained. Further details of preparation can be found in the aforesaid patent specifications.

The rutile form of titania is known to be more photostable than the anatase form and is therefore preferred.

Doped TiO₂ or doped ZnO may be obtained by flame pyrolysis or by plasma routes where mixed metal containing precursors at the appropriate dopant level are exposed to a flame or plasma to obtain the desired product.

Reduced zinc oxide particles (i.e. particles which possess an excess of zinc ions relative to the oxygen ions) may be readily obtained by heating zinc oxide particles in a reducing atmosphere to obtain reduced zinc oxide particles which absorb UV light, especially UV light having a wavelength below 390 nm, and re-emit in the green, preferably at about 500 nm. It will be understood that the reduced zinc oxide particles will contain reduced zinc oxide consistent with minimising migration to the surface of the particles of electrons and/or positively charged holes such that when said particles are exposed to UV light in an aqueous environment the production of hydroxyl radicals is substantially reduced as discussed above.

The reducing atmosphere can be air with a reduced oxygen content or an increased hydrogen content but is preferably a mixture of hydrogen and an inert gas such as nitrogen or argon. Typically the concentration of hydrogen is from 1 to 20%, especially 5 to 15%, by volume, with the balance inert gas, especially nitrogen. A preferred reducing atmosphere is about 10% hydrogen and about 90% nitrogen by volume. The zinc oxide is heated in this atmosphere at, say, 500° to 1000° C., generally 750 to 850° C., for example about 800° C., for 5 to 60 minutes, generally 10 to 30 minutes. Typically it is heated to about 800° C. for about 20 minutes.

It is believed that the reduced zinc oxide particles possess an excess of Zn²⁺ ions within the absorbing core. These are localised states and as such may exist within the band gap. A further discussion of this can be found in WO 99/60994.

The average primary particle size of the particles is generally from about 1 to 200 nm, for example about 1 to 150 nm, preferably from about 1 to 100 nm, more preferably from about 1 to 50 nm and most preferably from about 20 to 50 nm.

Where particles are substantially spherical then particle size will be taken to represent the diameter. However, the invention also encompasses particles which are non-spherical and in such cases the particle size refers to the largest dimension.

The particles used in the present invention may have an inorganic or organic coating. For example, the particles may be coated with oxides of elements such as aluminium, zirconium or silicon. The particles of metal oxide may also be coated with one or more organic materials such as polyols, amines, alkanolamines, polymeric organic silicon compounds, for example, RSi[{OSi(Me)₂}xOR¹]₃ where R is C₁-C₁₀ alkyl, R¹ is methyl or ethyl and x is an integer of from 4 to 12, hydrophilic polymers such as polyacrylamide, polyacrylic acid, carboxymethyl cellulose and xanthan gum or surfactants such as, for example, TOPO.

In the compositions the metal oxides are preferably present at a concentration of about 0.5 to 20% by weight, preferably about 1 to 10% by weight and more preferably about 3 to 8% by weight.

1. A polymeric composition which comprises an amount of one or more organic or inorganic components which are photosensitive and/or which are degraded by another ingredient of the composition and an amount of TiO₂ and/or ZnO which has been doped with a second element or reduced ZnO, the composition having a rate of deterioration of a UV light-sensitive physical factor at least 5% less than that of a composition having the same formulation except that it does not contain the said TiO₂ and/or ZnO which has been doped with a second element or reduced ZnO.

2. A composition according to claim 1 wherein the dopant comprises one or more of manganese, vanadium, chromium or iron.

3. A composition according to claim 2 wherein the dopant comprises Mn³⁺.

4. A composition according to claim 1 wherein the dopant is present in an amount from 0.05% to 10 mole %.

5. A composition according to claim 4 wherein the dopant is present in an amount from 0.5 to 2 mole % by weight.

6. A composition according to claim 1 which contains doped titanium dioxide.

7. A composition according to claim 1 wherein the titanium dioxide is in rutile form.

8. A composition according to claim 1 which contains doped ZnO.

9. A composition according to claim 1 which contains reduced ZnO.

10. A composition according to claim 1 which comprises 0.5 to 20 mole % by weight of the doped TiO₂ or ZnO or reduced ZnO.

11. A composition according to claim 1 wherein the doped material has a particle size from 1 to 100 nm.

12. A composition according to claim 1 wherein the physical factor is tensile strength.

13. A composition according to claim 1 wherein the physical factor is colour.

14. A composition according to claim 1 which comprises TiO₂ and/or ZnO which has not been doped or, in the case of ZnO, reduced.

15. A composition according to claim 14, wherein the said TiO₂ and/or ZnO is present as pigment.

16. A composition according to claim 1 wherein the polymeric composition is thermoplastic.

17. A composition according to claim 1 wherein the polymeric composition is thermosetting.

18. A composition according to claim 1 which is in the form of a three dimensional article.

19. A composition according to claim 1 which is in the form of a film.

20. A composition according to claim 19 which is in the form of a photographic film.

21. A composition according to claim 1 which is in the form of a coating composition.

22. A composition according to claim 21 which is in the form of a paint or varnish.

23. A self-supporting polymeric composition intended to protect a composition adjacent thereto from the adverse effects of light which comprises TiO₂ and/or ZnO which has been doped with a second element or reduced ZnO.

24. A composition according to claim 23 wherein the TiO₂ and/or ZnO is present in a surface layer.

25. A composition according to claim 24 wherein the non-surface layer is not wood.

26. A composition according to claim 24 wherein the non-surface layer is synthetic.

27. A varnish composition which comprises TiO₂ and/or ZnO which has been doped with a second element or reduced ZnO.

28. A composition according to claim 23, wherein the dopant comprises one or more of manganese, vanadium, chromium or iron.

29. (canceled)

30. A method for reducing the concentration of one or more light stabilisers in a polymeric composition comprising adding to the polymeric composition of a doped TiO₂/ZnO as defined in claim 1 or reduced ZnO to reduce the concentration of one or more light stabilisers in a polymeric composition.

31. A method for reducing the rate of deterioration of a light-sensitive physical factor in a polymeric composition comprising adding to the polymeric composition a doped TiO₂/ZnO as defined in claim 1 or reduced ZnO to reduce the rate of deterioration of a light-sensitive physical factor in a polymeric composition.

32. A method of improving stability of a physical factor of a polymeric composition, which comprises one or more components which are photosensitive and/or are degraded by another ingredient of the composition which comprises incorporating into the composition a doped TiO₂/ZnO as defined in claim 1 and/or reduced ZnO.
